(19) United States
(12) Patent Application Publication
(10) Pub. No.: US 2016/0277522 A1
(43) Pub. Date: Sep. 22, 2016

(54) DETECTING PLAYBACK BUFFER UNDERRUN AT SINK DEVICE TO IMPROVE STREAMING MEDIA QUALITY OVER BLUETOOTH

(71) Applicant: QUALCOMM Incorporated, San Diego, CA (US)

(72) Inventors: Rohit SINGH, Hyderabad (IN); Nitin SRIVASTAVA, Hyderabad (IN); Bhasker NETI, Hyderabad (IN)

(21) Appl. No.: 14/663,695

(22) Filed: Mar. 20, 2015

(51) Int. Cl. H04L 29/08; H04L 29/06; H04L 12/911; H04W 4/00; H04L 12/26

(52) U.S. Cl. CPC H04L 67/2842; H04W 4/008; H04L 43/0876; H04L 47/82; H04L 65/4069

(57) ABSTRACT

The disclosure generally relates to detecting playback buffer underrun at a sink device to improve streaming media quality. More particularly, according to various embodiments, a media source device may establish a connection with the sink device according to a short-range wireless communication protocol (e.g., Bluetooth) and stream multimedia data to the sink device over the established connection. The sink device may then store the streamed multimedia data in a playback buffer, render the streamed multimedia data from the playback buffer, and send a signal to the source device to indicate a status associated with the playback buffer. Accordingly, the source device may increase local resources allocated to streaming the multimedia data to the sink device in response to the status signal indicating an underrun condition in the playback buffer at the sink device (e.g., where the buffered multimedia data stored therein has fallen below a threshold).

### TECHNICAL FIELD

The various aspects and embodiments described herein generally relate to streaming multimedia over a wireless connection, and more particularly, to detecting playback buffer underrun at a multimedia sink device to improve streaming media quality over Bluetooth.

### BACKGROUND

Wireless devices operating in the “Bluetooth” wireless communication spectrum are proliferating. In particular, the term “Bluetooth” generally refers to and defines a relatively short range wireless communication protocol, with an operating range ranging from a few meters to a few tens of meters. The Bluetooth specification includes various profiles that define the behavior associated with each communication endpoint to implement a specific use case. Several such use cases are contemplated in the Bluetooth specification, which are generally defined according to a protocol stack that promotes and allows interoperability between endpoint devices from different manufacturers through enabling applications to discover and use services that other nearby Bluetooth devices may be offering.

In that context, the Bluetooth specification defines device role pairs that together form a single use case called a Profile. One example Profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device implements an audio source device (SRC) role and another device implements an audio sink device (SNK) role. In order for a commercial Bluetooth device that implements one role in a Profile to function properly, another device that implements the corresponding role must be present within the radio range of the first device. For example, in order for an HF device such as a Bluetooth headset to function according to the Handsfree Profile, a device implementing the AG role (e.g., a cell phone) must be present within radio range. Likewise, in order to stream high-quality mono or stereo audio according to the A2DP, a device implementing the SNK role (e.g., Bluetooth headphones or Bluetooth speakers) must be within radio range of a device implementing the SRC role (e.g., a stereo music player).

Accordingly, in the Bluetooth specification, the A2DP generally defines the protocols and procedures to stream high-quality audio content in mono or stereo from a source device to a sink device on Asynchronous Connection-Less (ACL) channels over a Bluetooth connection. For example, audio can be streamed from a mobile phone, laptop computer, microphone, or other suitable source device to a wireless headset, car audio system, or other suitable sink device. Moreover, although the Bluetooth specification distinguishes the term “advanced audio” from “Bluetooth audio” that refers to narrow band voice distributed on Synchronous Connection Oriented (SCO) channels, A2DP systems often further implement the Headset Profile (HSP) or HFP to support telephone calls separately from streaming multimedia audio. Furthermore, while the A2DP focuses on audio streaming, the Video Distribution Profile (VDP) specifies the protocols and procedures to stream video content, whereby source and sink devices that support both the A2DP and VDP can distribute video content accompanied with high-quality audio.

Accordingly, because streaming audio according to the A2DP can be performed in combination with other Bluetooth use cases, one frequent issue reported on A2DP involves audio choppiness. For example, each A2DP service generally transfers an audio stream in one direction, either to or from a Bluetooth host, which may create challenges with respect to supporting and maintaining A2DP audio quality during multiple ACL connections, which are typically used when data is more important than avoiding latency (e.g., a device under test (DUT) connected to a Human Interface Device (HID) mouse and HID keyboard while performing a file transfer). More particularly, because Bluetooth firmware typically has limited ACL buffers that need to be distributed among multiple ACL connections, allocating the ACL buffers intelligently to not affect the performance associated with other connections becomes an important concern. Furthermore, radio frequency (RF) tends to have a bursty nature, which can lead to situations where a particular source device may momentarily lack the ability to send data to the sink device due to interference or other bad RF conditions on a particular channel such that the sink device will start to utilize audio samples that were buffered locally. In the event that the above-mentioned scenario continues and/or repeats periodically, the A2DP sink device may consume the locally buffered audio samples, resulting in buffer underrun at the A2DP sink device because the A2DP source device cannot fill the ACL buffer at the A2DP sink device in situations where there are multiple simultaneous ACL connections (even under good RF conditions) due to the need to distribute the ACL buffers among the multiple ACL connections.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method for detecting playback buffer underrun at a sink device may comprise establishing a connection with the sink device according to a short-range wireless communication protocol, streaming multimedia data to the sink device over the established connection, wherein the sink device stores the streamed multimedia data in a playback buffer and renders the streamed multimedia data from the playback buffer, and increasing local resources allocated to streaming the multimedia data to the sink device in response to a signal received from the sink device indicating that the multimedia data stored in the playback buffer at the sink device has fallen below a threshold. Furthermore, in various embodiments, the local resources allocated to streaming the multimedia data may be increased in response to detecting packet loss due to radio frequency (RF) interference over the short-range wireless connection, and the multimedia data may be transmitted to the sink device at an increased frequency in response to the signal indicating that the multimedia data stored in the playback buffer at the sink device has fallen below the threshold. In a related aspect, the method may comprise decreasing the local resources allocated to streaming the multimedia data to the sink device in response to the sink device indicating that the multimedia data stored in the playback buffer has increased above the threshold. Furthermore, according to various aspects, the short-range wireless connection may comprise an Asynchronous Connection-Less (ACL) session, and the local resources allocated to the stream may comprise local buffer resources that a Host Controller Interface (HCI) has allocated to another ACL session.

According to various aspects, a media source device may comprise means for establishing a connection with a media sink device according to a short-range wireless communication protocol, means for streaming multimedia data to the media sink device over the established connection, wherein the media sink device stores the streamed multimedia data in a playback buffer and renders the streamed multimedia data from the playback buffer, and means for increasing local resources allocated to streaming the multimedia data to the media sink device in response to a signal received from the media sink device indicating that the multimedia data stored in the playback buffer at the media sink device has fallen below a threshold.

According to various aspects, a computer-readable storage medium may have computer-executable instructions recorded thereon, wherein executing the computer-executable instructions on a wireless device may cause the wireless device to establish a connection with a media sink device according to a short-range wireless communication protocol, stream multimedia data to the media sink device over the established connection, wherein the media sink device stores the streamed multimedia data in a playback buffer and renders the streamed multimedia data from the playback buffer, and increase local resources allocated to streaming the multimedia data to the media sink device in response to a signal received from the media sink device indicating that the multimedia data stored in the playback buffer at the media sink device has fallen below a threshold.

According to various aspects, an apparatus may comprise a transmitter configured to stream multimedia data to a sink device over a short-range wireless connection, wherein the sink device is configured to store the streamed multimedia data in a playback buffer and render the streamed multimedia data from the playback buffer, a receiver configured to receive a signal from the sink device indicating that the streamed multimedia data stored in the playback buffer has fallen below a threshold, and one or more processors configured to increase local resources allocated to the short-range wireless connection used to stream the multimedia data to the sink device in response to the received signal from the sink device. For example, in various embodiments, the transmitter may be configured to transmit the streamed multimedia data to the sink device at an increased frequency in response to the signal received from the sink device. Furthermore, in various embodiments, the apparatus may comprise a signal detector configured to detect packet loss due to radio frequency (RF) interference on the short-range wireless connection, and the one or more processors may be further configured to increase the local resources allocated to the short-range wireless connection used to stream the multimedia data to the sink device in response to the detected packet loss. Additionally, in various embodiments, the one or more processors may be further configured to decrease the local resources allocated to the short-range wireless connection used to stream the multimedia data to the sink device in response to the sink device indicating that the streamed multimedia data stored in the playback buffer has increased above the threshold.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a relationship between the Bluetooth protocol stack and the Open Systems Interconnect (OSI) seven-layer model, according to various aspects.

FIG. 2 illustrates an implementation using the Bluetooth protocol stack to support multiple Asynchronous Connection-Less (ACL) connections, according to various aspects.

FIG. 3 illustrates dependency relationships associated with the Advanced Audio Distribution Profile (A2DP) and the Video Distribution Profile (VDP) defined in the Bluetooth specification, according to various aspects.

FIG. 4 illustrates an exemplary model associated with a source device and a sink device implementing an A2DP and/or VDP use case, according to various aspects.

FIG. 5 illustrates exemplary procedures and packet formats used to stream high-quality audio and/or video from a source device to a sink device to implement an A2DP and/or VDP use case, according to various aspects.

FIG. 6 illustrates an exemplary signaling flow in which a media source device can detect playback buffer underrun at a media sink device and allocate resources to streaming media to the sink device to improve streaming quality, according to various aspects.

FIG. 7 illustrates an exemplary wireless device that can implement the various aspects and embodiments disclosed herein, according to various aspects.

### DETAILED DESCRIPTION

Various aspects are disclosed in the following description and related drawings to show specific examples relating to exemplary embodiments. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

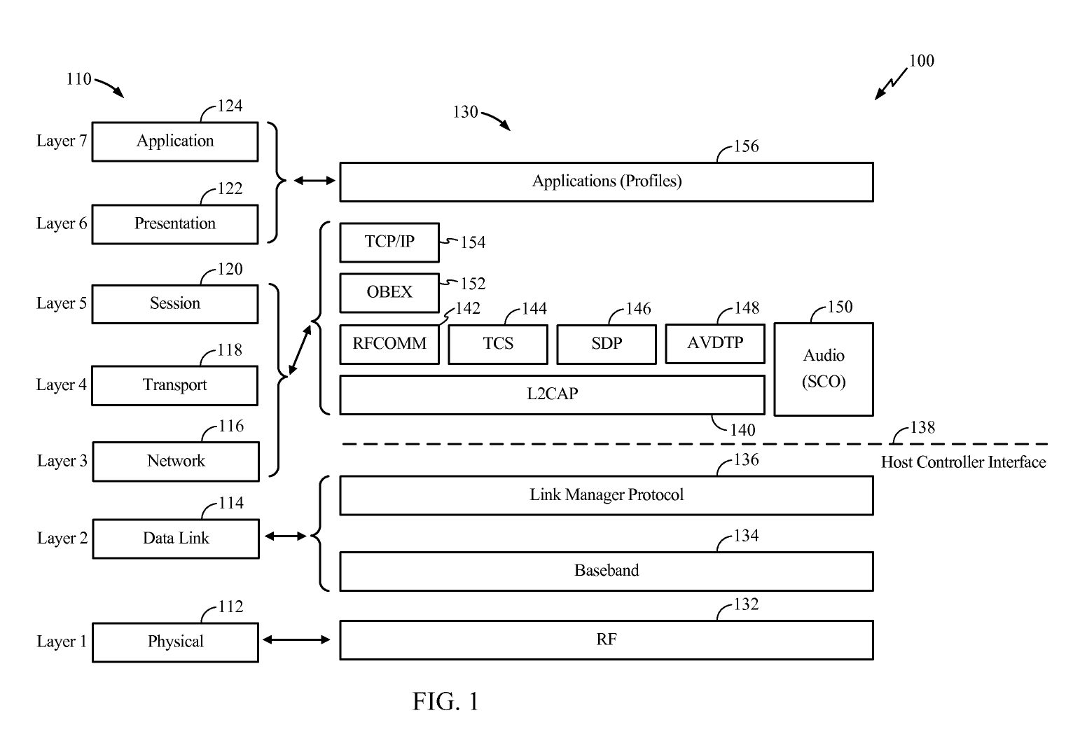

According to various aspects, FIG. 1 illustrates a relationship between the Bluetooth protocol stack 130 and the Open Systems Interconnect (OSI) seven-layer model 110, which was established to standardize information transmission between points over the Internet or other wired and/or wireless networks. In particular, the OSI model 110 generally separates communications processes between two points in a network into seven stacked layers, with each layer adding certain functions. Each device handles a message such that a downward flow through each layer occurs at a sending endpoint and an upward flow through the layers occurs at a receiving endpoint. The programming and/or hardware that provides the seven layers in the OSI model 110 is typically a combination of device operating systems, application software, TCP/IP and/or other transport and network protocols, and other software and hardware.

More particularly, referring to FIG. 1, the OSI model 110 includes a physical layer 112 (Layer 1) used to convey a bit stream through a network at a physical level. The Institute of Electrical and Electronics Engineers (IEEE) sub-divides the physical layer 112 into the PLCP (Physical Layer Convergence Procedure) sub-layer and the PMD (Physical Medium Dependent) sub-layer. The data link layer 114 (Layer 2) provides physical level synchronization, performs bit-stuffing, and furnishes transmission protocol knowledge and management, etc. The IEEE sub-divides the data link layer 114 into two further sub-layers, which comprise the Media Access Control (MAC) sub-layer to control data transfer to and from the physical layer and the Logical Link Control (LLC) sub-layer to interface with the network layer 116 (Layer 3), interpret commands, and perform error recovery.

Still referring to FIG. 1, the network layer 116 (Layer 3) handles data transfer across a network (e.g., routing and forwarding) in a manner independent from any media and specific network topology, the transport layer 118 (Layer 4) manages end-to-end control and error-checking to multiplex data transfer across the network according to application-level reliability requirements, and the session layer 120 (Layer 5) establishes, coordinates, and terminates conversations, exchanges, and dialogs between the applications to provide management and data flow control services.

Still referring to FIG. 1, the presentation layer 122 (Layer 6) converts incoming and outgoing data from one presentation format to another, which may comprise adding service structure to the data units to provide data to the application layer 124 (Layer 7) according to a common representation, while the application layer 124 is where communication partners are identified, quality of service (QoS) is identified, user authentication and privacy are considered, constraints on data syntax are identified, and any other functions relevant to managing communications between host applications are managed.

Turning now to the Bluetooth protocol stack 130, the radio frequency (RF) layer 132 generally corresponds to the physical layer 112 in the OSI model 110, the baseband layer 134 and the link manager protocol layer 136 generally correspond to the data link layer 114, and a host controller interface 138 separates the RF layer 132, the baseband layer 134, and the link manager protocol layer 136 from the upper layers. For example, the Physical Layer 112 in the OSI model 110 manages electrical interfaces to communications media, which includes modulation and channel coding, and therefore covers the Bluetooth radio in the RF layer 132 (and possibly part of the baseband layer 134), while the data link layer 114 manages transmission, framing, and error control over a particular link, which overlaps tasks performed in the link manager protocol layer 136 and the control end of the baseband layer 134 (e.g., error checking and correction).

Above the host controller interface 138, the Logical Link Control and Adaptation Protocol (L2CAP) 140, RF communication (RFCOMM) 142, Synchronous Connection Oriented (SCO) Audio 150, object exchange (OBEX) 152, TCP/IP 154, Service Discovery Protocol (SDP) 146, Telephony Control Specification (TCS) 144, and Audio/Video Distribution Transport Protocol (AVDTP) 148 functions correspond to the network layer 116, transport layer 118, and session layer 120. The applications layer 156 comprises the Bluetooth Profiles (e.g., HFP for voice, A2DP for high-quality audio streaming, VDP for video streaming, etc.) and corresponds to the presentation layer 122 and the application layer 124 in the OSI model 110. Accordingly, a Bluetooth Profile may generally be considered synonymous with an “application” in the OSI seven-layer model 110. In relation to the Bluetooth HFP, the RFCOMM channel 142 comprises a communication channel named “service level connection” (“SLC”) that emulates a serial port used for further communication between an Audio Gateway (AG) device and a Handsfree (HF) device. For voice audio connections, such as in the Bluetooth HFP, a separate baseband link called a synchronous connection-oriented (SCO) channel carries the voice data, represented as audio function 150 in FIG. 1. For A2DP, the audio data (unidirectional high-quality audio content, which may be in mono or stereo) goes over AVDTP 148, which in turn goes over L2CAP 140. At the radio level, all L2CAP 140 data flows over an Asynchronous Connection-Less (ACL) radio link, which refers to a different baseband link than SCO. As such, the audio function 150 only applies to voice data (bidirectional mono data) that flows directly between two Bluetooth radios, whereas A2DP audio data is compressed in a proper format to ensure efficient use of limited bandwidth.

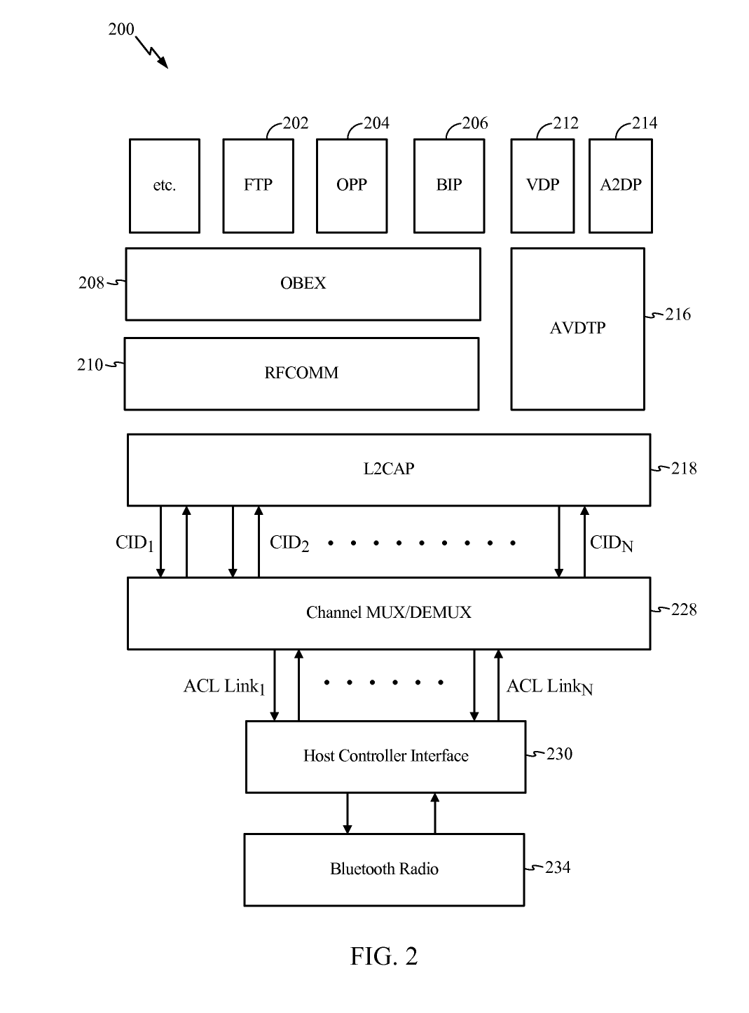

According to various aspects, FIG. 2 illustrates an implementation using the Bluetooth protocol stack 200 to support multiple ACL connections. For example, the File Transfer Protocol (FTP) 202 provides a method to transfer files without the loss of data, which can include all file types including binary and ASCII text, the Object Push Profile (OPP) 204 is used by applications to push an object such as a business card or appointment information to a Bluetooth device, the Basic Imaging Profile (BIP) 206 establishes the fundamental requirements to enable negotiation of the size and encoding of image-related data, the OBEX Protocol 208 is a set of high level protocols that controls the exchange of objects between Bluetooth devices, the RFCOMM 210 is a protocol based upon the standard for serial port emulation which has been adopted for Bluetooth, and the Video Distribution Profile (VDP) 212 and Advanced Audio Distribution Profile (A2DP) 214 sit on top of the Audio Video Data Transport Protocol (AVDTP) 216, which defines procedures to establish, negotiate, and stream audio/video from a source to a sink device.

According to various embodiments, as mentioned above, an important part of the Bluetooth protocol stack 200 is the L2CAP layer 218, which provides multiplexing (MUX) and demultiplexing (DEMUX) capabilities in the Bluetooth protocol stack 200. For example, the L2CAP layer 218 may establish a Channel ID (CID) link to a MUX/DEMUX sublayer 228, wherein a CID refers to a logical connection on the L2CAP 218 level between two devices serving a single application or higher layer protocol. The MUX/DEMUX sublayer 228 may operate over an Asynchronous Connection-Less (ACL) link that the baseband layer protocols provide, wherein the ACL link is generally a point-to-multipoint, asynchronous (i.e., not synchronized with time), packetized (i.e., messages are broken into smaller packets for transmission) link between the transmitting device and the receiving device. The Host Controller Interface (HCI) 230, upon receipt of data over an ACL link, communicates the lower layer protocols to the host device (such as a Bluetooth-enabled laptop or mobile phone). The HCI 230 therefore represents the command interface to the baseband controller and provides uniform access to the baseband capabilities controlling the Bluetooth radio 234.

Accordingly, because streaming audio over A2DP 214 can be performed in combination with other Bluetooth use cases, audio choppiness on A2DP 214 can occur during multiple ACL connections, which are typically used when data is more important than avoiding latency (e.g., to connect a Bluetooth device to a Human Interface Device (HID) mouse and HID keyboard while performing a file transfer). In particular, Bluetooth firmware typically has limited ACL buffers that need to be distributed among multiple ACL connections intelligently and radio frequency (RF) tends to have a bursty nature, which are just two conditions that may force an A2DP sink device to start utilizing buffered audio samples and eventually consume the data stored in the local buffer. Furthermore, despite the fact that the current Bluetooth specifications note that streaming high-quality audio over A2DP 214 and streaming video content over VDP 212 are both subject to certain delays between the source device and the sink device due to radio signal processing, data buffering, and the time required to encode and decode the streaming data at the source device and the sink device, respectively, the Bluetooth specifications do not provide any solutions to these or other problems that may lead to buffer underrun at the sink device, instead stating that countering the effects from such delays are implementation-dependent.

In order to address the above-mentioned problems and further improve high-quality audio streaming and/or video streaming over Bluetooth, a mechanism to determine the health associated with the buffer at an A2DP/VDP sink device and thereby detect playback buffer underrun at the A2DP/VDP sink device is provided herein. In particular, the A2DP/VDP sink device may periodically communicate with the A2DP/VDP source device to provide updated information relating to the local buffer health at the A2DP/VDP sink device. Accordingly, when the A2DP/VDP source device observes that the buffer at the A2DP/VDP sink device has fallen below a threshold value or otherwise may be approaching consumption, the A2DP/VDP source device may dynamically take over one or more buffers allocated to other ACL connections and attempt to pump more data to the A2DP/VDP sink device to compensate the current buffer state. For example, the A2DP/VDP sink device may signal the A2DP/VDP source device when the data remaining in the buffer at the A2DP/VDP sink device has been consumed (or is approaching consumption), and in response thereto, the A2DP/VDP source device may allocate additional buffers at the HCI layer 230 to clear the local buffer and thereby transmit data to the A2DP/VDP sink device more frequently. In particular, although the HCI 230 standardizes communication between the host stack (e.g., the A2DP/VDP source device) and the controller (e.g., the Bluetooth controller) and provides flow control to avoid overflowing the data buffers at the controller with ACL destined for an unresponsive remote device, allocating the additional buffers at the HCI 230 to the media data being streamed to the A2DP/VDP sink device may not cause overflow problems where the A2DP/VDP sink device is responsive and simply experiencing buffer underrun.

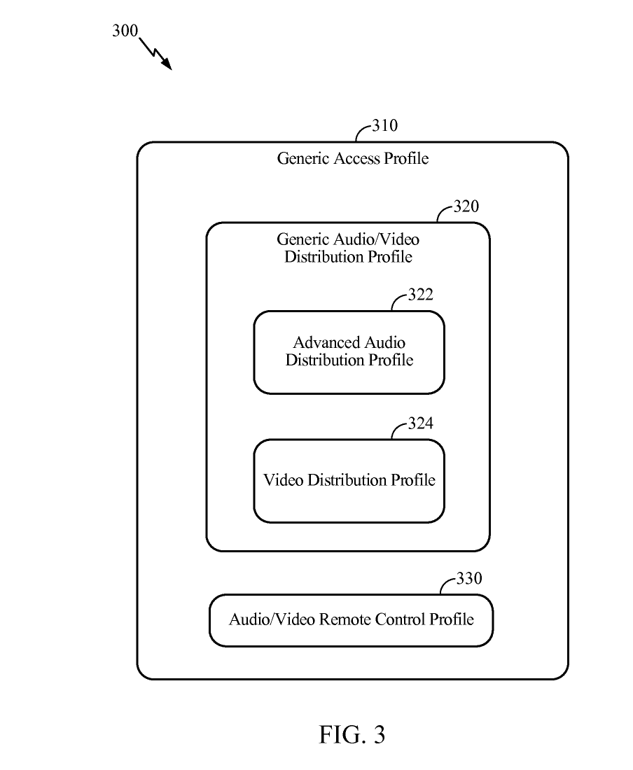

According to various aspects, FIG. 3 illustrates dependency relationships associated with the Advanced Audio Distribution Profile (A2DP) 322 and the Video Distribution Profile (VDP) 324 defined in the Bluetooth specification. More particularly, a first profile may generally be considered dependent upon a second profile where the first profile re-uses part of the second profile, which may comprise implicitly or explicitly referencing the part of the second profile re-used in the first profile. Accordingly, a profile has dependencies on the profile(s) that contain the profile, whether directly or indirectly. For example, as shown in FIG. 3, the A2DP 322 and the VDP 324 depend on the Generic Access Profile (GAP) 310, which defines how two Bluetooth units discover and establish a connection with one another to provide the basis for all other Bluetooth Profiles. In addition, the A2DP 322 and the VDP 324 depend on the Generic Audio/Video Distribution Profile (GAVDP) 320, which defines procedures required to establish an audio/video streaming session. In general, the GAVDP 320 defines two roles, which comprise an Initiator that initiates a signaling procedure and an Acceptor that responds to an incoming request from the Initiator. However, the Initiator and Acceptor roles are not fixed to the devices; instead, the roles are determined when one device initiates a signaling procedure, released when the procedure ends, and can be switched between two devices when a new procedure is initiated. The Audio/Video Remote Control Profile (AVRCP) 330 generally provides a standard interface to allow a single remote control to control all audio/video equipment to which a user has access, where the AVRCP 330 can be used in combination with the A2DP 322 and the 324 VDP (e.g., the AVRCP 330 is often used in vehicles to control streaming Bluetooth audio). Furthermore, although not shown in FIG. 3, the A2DP 322 and VDP 324 utilize the baseband, LMP, L2CAP, and SDP protocols defined in the Bluetooth Core specifications in addition to the AVDTP, which may provide a signaling entity that can negotiate streaming parameters and a transport entity that can handle streaming via the A2DP 322 and the VDP 324.

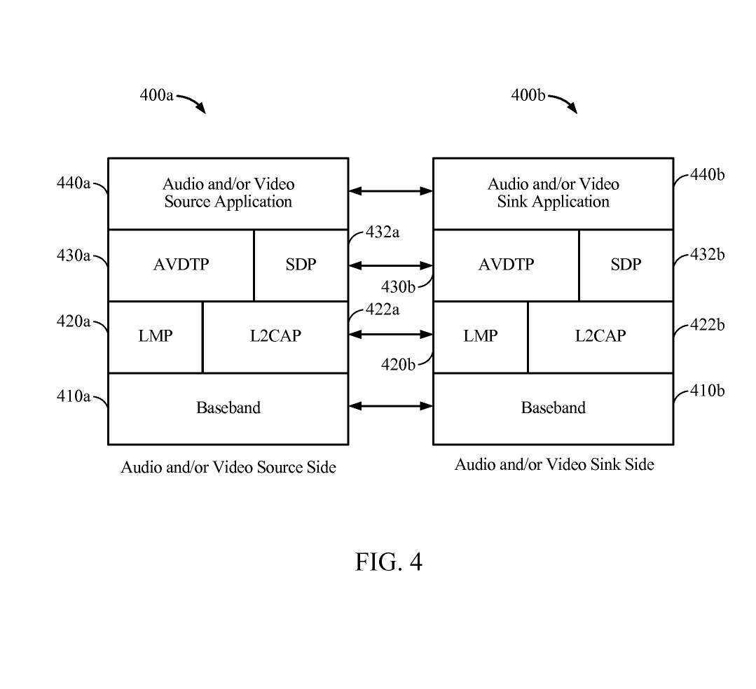

According to various aspects, FIG. 4 illustrates an exemplary model associated with a media source device 400a and a media sink device 400b implementing an A2DP and/or VDP use case. More particularly, as shown in FIG. 4, the A2DP and VDP use cases both involve the Baseband 410, which may be used to specify or otherwise implement the medium access and physical layer procedures between the media source device 400a and the media sink device 400b. Additionally, the A2DP and VDP use cases both involve the Link Manager Protocol (LMP) 420, which may control and negotiate the operation of the connection between the media source device 400a and the media sink device 400b (e.g., setting up and controlling logical transports and logical links, controlling physical links, communicating between the Link Managers (LM) on the media source device 400a and the media sink device 400b that are connected through an Asynchronous Connection-Less (ACL) logical transport, etc.).

Furthermore, in various embodiments, the L2CAP 422 may support higher-level protocol multiplexing, packet segmentation and reassembly, and conveying quality of service (QoS) information, which may permit the higher level protocols and applications 440 to transmit and receive upper layer data packets (e.g., audio content, video content, or both) up to sixty-four kilobytes in length. The L2CAP 422 may further permit per-channel flow control and retransmission via the Flow Control and Retransmission Modes, provide logical channels and named L2CAP channels that map to L2CAP logical links supported by an ACL logical transport, and assign local a channel identifier (CID) to represent logical channel endpoints on the media source device 400a and the media sink device 400b. However, CID assignment is relative to the media source device 400a and the media sink device 400b and one can assign CIDs independently from the other (unless any of several reserved CIDs are needed). Furthermore, the ACL channels generally restrict data flow to a single direction, whereby the ACL channels are used to support a channel “group” where a CID on the media source device 400a represents the media sink device 400b, and one or more CIDs may be reserved for special purposes (e.g., a signaling channel used to negotiate changes in ACL channels, which the media sink device 400b may use to transmit playback buffer health information to the media source device 400a such that the media source device 400a can adjust local resources allocated to the stream according to the playback buffer status at the sink device 400b).

In various embodiments, the A2DP and VDP use cases may both further involve the Service discovery protocol (SDP) 432, which is bound to L2CAP 422 and allows the media source device 400a and the media sink device 400b to discover what services each other support and what parameters to use in order to connect to such services (e.g., the protocol multiplexer settings needed to connect to the A2DP and/or VDP on the other device). The AVDTP 430 provides a signaling entity to negotiate streaming parameters and a transport entity that can handle the actual streaming, while the Application layer 440 shown in FIG. 4 defines application service and transport service parameters, which may include adapting the streaming media data into the defined packet format.

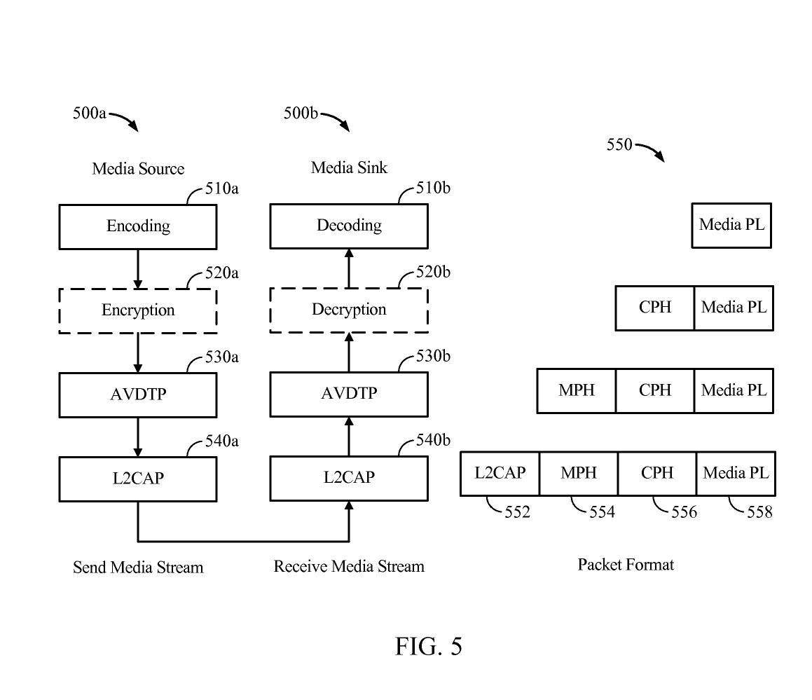

According to various aspects, FIG. 5 illustrates exemplary procedures and packet formats used to stream high-quality audio from a media source device 500a to a media sink device 500b and thereby implement an A2DP and/or VDP use case. More particularly, if the AVDTP version of the media sink device 500b is unknown to the media source device 500a (or vice versa), the media source device 500a may initially perform an SDP query to request and receive the AVDTP version from the media sink device 500b prior to a connection establishment procedure (e.g., because some commands in the A2DP audio streaming setup procedure depend on the AVDTP version). Furthermore, in a VDP use case, the source device 500a and the sink device 500b may each support two stream endpoints, which comprise one audio endpoint and one video endpoint. As such, in VDP use cases, the source device 500a may also initiate a stream endpoint discovery procedure that serves to return a media type and identifiers associated with the two stream endpoints on the sink device 500b. In various embodiments, when the source device 500a wants to start streaming audio content and/or video content, the source device 500a may establish a streaming connection, which may comprise a signaling flow in which the source device 500a and the sink device 500b learn application service capabilities (e.g., audio/video codec capabilities) and transport service capabilities associated with one another and select the most suitable streaming parameters. For example, the application service capabilities may comprise audio codec capabilities in A2DP use cases (e.g., mode, sampling frequency, bit rate, etc.), video codec capabilities in VDP use cases (e.g., mode, frame rate, bit rate, etc.), and optional content protection capabilities in either A2DP or VDP use cases. Furthermore, AVDTP may provide the transport service capabilities to manipulate the streaming packets more intelligently and thereby increase channel throughput.

In various embodiments, once a streaming connection has been established and a start streaming procedure is executed, both the media source device 500a and the media sink device 500b may be in a streaming state, in which the media source device 500a is ready to send a media stream containing audio and/or video content and the media sink device 500b is ready to receive the media stream. In general, the media source device 500a may send the media stream to the media sink device 500b according to a send stream procedure that encapsulates the data according to a packet format 550 as shown in FIG. 5, and the sink media sink device 500b in turn employs a receive stream procedure to receive and decapsulate the media data according to the packet format 550. Accordingly, in the send stream procedure, the media source device 500a may initially encode the data into a selected format in the signaling session at 510a (if necessary), and the application layer at the media source device 500a may then adapt the encoded data into a defined media payload (PL) format 558. In the event that the media source device 500a and media sink device 500b are using content protection, a content protection header (CPH) 556 may precede encrypted media content created at 520a. The streaming media data may then be handed down to the AVDTP entity at 530a, at which time a media packet header (MPH) 554 may be added to precede the CPH 556 (if any) and the media payload 558. The streaming media data may then be sent on the appropriate transport channel via the L2CAP 540a at the media source device 500a with an L2CAP header 552, which may then be received at the L2CAP 540b at the media audio sink 500b. Furthermore, in VDP use cases, the media source device 500a and the media sink device 500b may generally carry out two streaming procedures according to the procedures and packet format described above, which comprise one stream between the respective audio endpoints on the media source device 500a and the media sink device 500b and one stream between the respective video endpoints on the media source device 500a and the media sink device 500b.

Accordingly, in various embodiments, the AVDTP entity 530b at the media sink device 500b may then receive the streaming media data from the transport channel, remove the MPH 554, and pass the data on to the application layer. Furthermore, where content protection method is active, the application layer at the media sink device 500b may process the AVDTP payload according to the content protection method, which typically involves analyzing the CPH 556 and decrypting the encrypted content at 520b. The media payload 558 (i.e., an audio data frame in an A2DP use case, or a data frame that contains encoded video and/or pre-multiplexed audio and video data in a VDP use case) may then be decoded according to the selected coding format (if applicable) at 510b and ready for buffering and playback at the media sink device 500b.

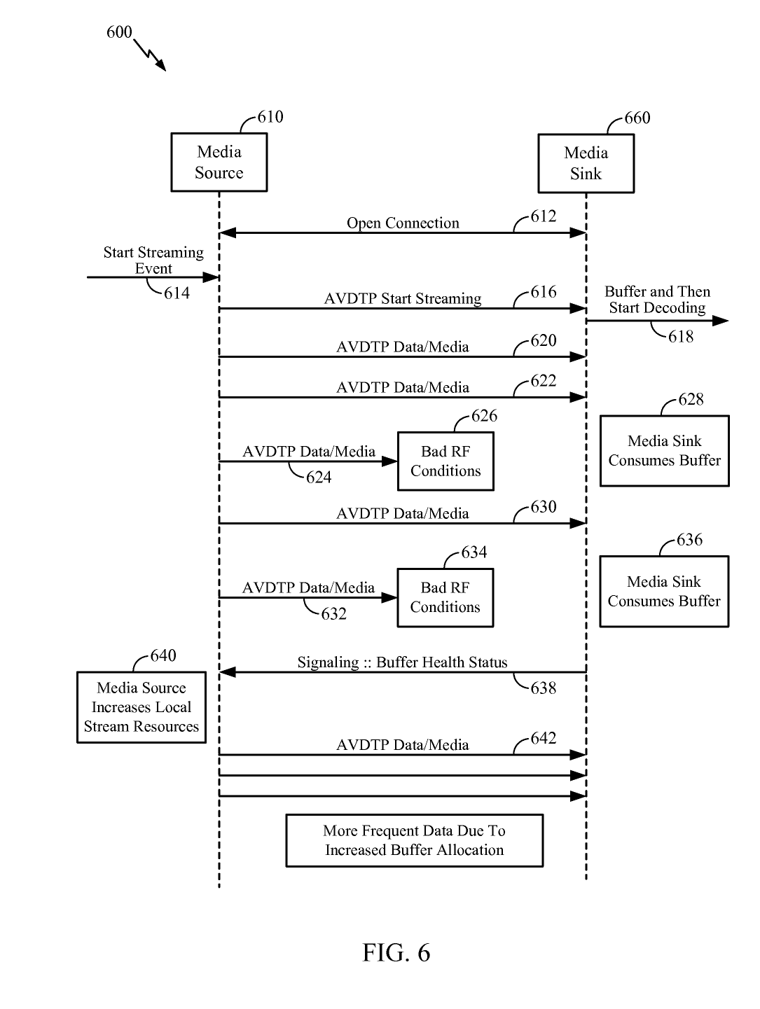

According to various aspects, FIG. 6 illustrates an exemplary signaling flow 600 in which a media source device 610 can detect playback buffer underrun at a media sink device 660 and allocate resources to streaming media to the media sink device 660 in order to improve streaming quality. More particularly, at 612, the media source device 610 may open a connection with the media sink device 660, which may comprise discovering one or more streaming endpoints, learning all capabilities associated with the media sink device 660, and configuring and establishing one or more streaming connections (e.g., coordinating streaming parameters such as audio and/or video codec modes, sampling frequencies, bit rates, optional content protection, etc.).

In various embodiments, once the streaming connection has been established and a start streaming event occurs at 614, a start streaming procedure may be executed at 616, wherein the start streaming procedure may comprise the media source device 610 starting to send the media data stream to the media sink device 660. For example, in various embodiments, the media data stream sent from the media source device 610 to the media sink device 660 may comprise audio content streamed to an Advanced Audio Distribution Profile (A2DP), video content streamed according to a Video Distribution Profile (VDP), video content streamed according to the VDP in addition to audio content streamed according to the A2DP to accompany the streamed video content, or any suitable combination thereof. In any case, the media sink device 660 may store the streaming media data in a playback buffer and then start to decode the buffered media data at 618 (e.g., after the playback buffer has been filled or a certain threshold amount of data has been buffered, which typically takes about 50 milliseconds under good radio conditions). Accordingly, under normal conditions, the media source device 610 may continue to transmit streaming data/media to the media sink device 660 at 620, 622, 630. However, radio frequency (RF) tends to have a bursty nature, which can lead to situations where the media source device 610 may momentarily lack the ability to send data to the media sink device 660 due to interference or other bad RF conditions on a particular channel, as depicted at 626, 634. As such, the data/media that the media source device 610 transmits at 624, 632 may not reach the media sink device 660, which may result in the media sink device 660 starting to utilize locally buffered media samples at 628, 636. If the media sink device 660 were to consume the locally buffered media samples entirely, buffer underrun would then result at the media sink device 660 because the media source device 610 cannot fill the ACL buffer(s) at the media sink device 660 (e.g., due to the bad RF conditions at 626, 630, because there are multiple simultaneous ACL connections among which the media source device 610 needs to allocate the ACL buffers, etc.). Accordingly, to avoid having the media sink device 660 entirely consume the locally buffered media samples or otherwise experience buffer underrun that would likely degrade playback quality, the media sink device 660 may transmit a buffer health status signal at 638 such that the media source device 610 may receive updated information relating to the local buffer health at the media sink device 660.

Accordingly, when the media source device 610 observes that the buffer at the media sink device 660 has fallen below a threshold value or otherwise may be approaching consumption at 616, the media source device 610 may dynamically take over one or more buffers allocated to other ACL connections and attempt to pump more data to the media sink device 660 to compensate the current buffer state. For example, as shown at 640, the media source device 610 may allocate a Host Controller Interface (HCI) buffer in order to clear the local buffer, thereby causing the media source device 610 to transmit more data to the media sink device 660 and/or transmit the data to the media sink device 660 more frequently due to the increase in the buffers allocated to the media stream, as shown at 642. In particular, although the HCI architecture provides standardized flow control to avoid overflowing data buffers at the Bluetooth controller with ACL data destined for an unresponsive remote device, where the media sink device 660 is responsive and simply experiencing buffer underrun, allocating the HCI buffers to the media data streamed to the media sink device 660 may not cause overflow problems. In this manner, the media sink device 660 may periodically inform the media source device 610 about the current playback buffer health status such that the media source device 610 can dynamically increase the local resources allocated to the ACL connection with the media sink device 660 (e.g., where the playback buffer has been consumed, the media data stored in the playback buffer has fallen below a threshold value, etc.). Furthermore, in response to the media sink device 660 sending a subsequent buffer health status signal (not shown) to the media source device 610 indicating that the media data stored in the playback buffer at the media sink device 660 has returned to normal, reached a level that exceeds the threshold value, etc., the media source device 610 may decrease the resources allocated to streaming the media data to the media sink device 660, which may comprise restoring the local resources that were taken from other ACL connections and resuming normal operation.

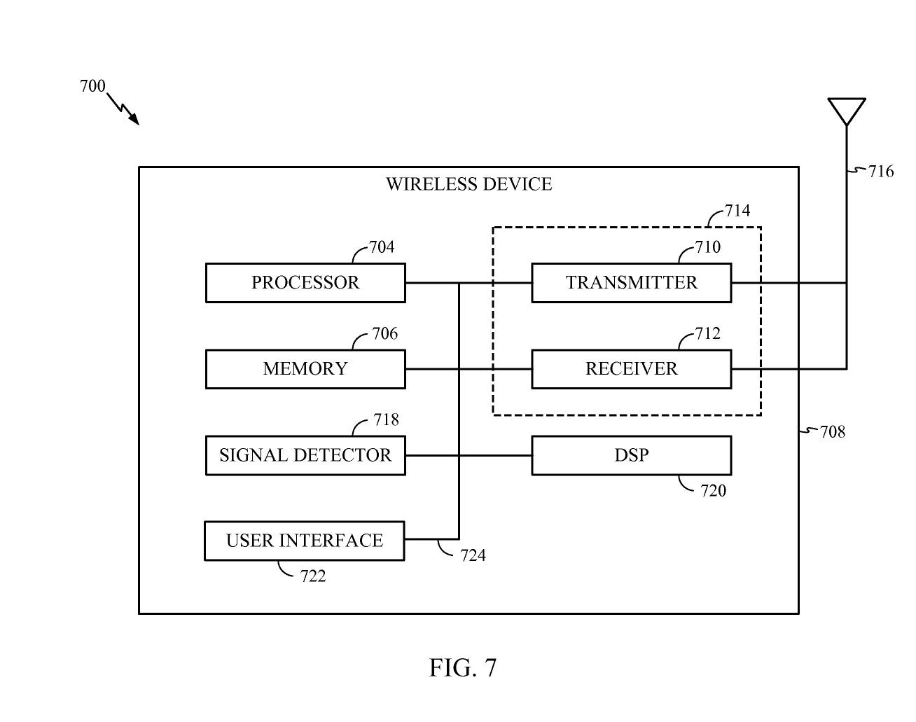

According to various aspects, FIG. 7 illustrates a block diagram representing an exemplary wireless device 700 into which the aspects and embodiments disclosed herein can be incorporated. For example, the wireless device 700 may correspond to a source device that can stream audio and/or video content to a sink device (e.g., according to the A2DP and/or VDP defined in the Bluetooth specification) and adjust local resources allocated to the audio/video stream according to a playback buffer status at the sink device, or the wireless device 700 can correspond to the sink device that receives streaming audio and/or video content from the source device, stores the streaming audio/video content in a playback buffer prior to rendering, and signals the source device to indicate the status associated with the playback buffer.

In various embodiments, the wireless device 700 can include a processor 704, a memory 706, a housing 708, a transmitter 710, a receiver 712, an antenna 716, a signal detector 718, a digital signal processor (DSP) 720, a user interface 722, and a bus 724. Alternatively, the functions of the transmitter 710 and the receiver 712 can be incorporated into a transceiver 714. The wireless device 700 can be configured to communicate in a wireless network that includes, for example, a base station (not illustrated), an access point (not illustrated), and the like.

The processor 704 can be configured to control operations of the wireless device 700. The processor 704 can also be referred to as a central processing unit (CPU). The memory 706 can be coupled to the processor 704, can be in communication with the processor 704, and can provide instructions and data to the processor 704. The processor 704 can perform logical and arithmetic operations based on program instructions stored within the memory 706. The instructions in the memory 706 can be executable to perform one or more of the methods and processes described herein.

The processor 704 can include, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information.

The processing system can also include machine-readable media for storing software. Software can be construed broadly to mean any type of instructions, whether referred to as software, firmware, middleware, microcode, hardware description language, or otherwise. Instructions can include code, e.g., in source code format, binary code format, executable code format, or any other suitable format of code. The instructions, when executed by the one or more processors, can cause the processing system to perform one or more of the functions described herein.

The memory 706 can include both read-only memory (ROM) and random access memory (RAM). A portion of the memory 706 can also include non-volatile random access memory (NVRAM).

The transmitter 710 and the receiver 712 (or the transceiver 714) can allow transmission and reception of data between the wireless device 700 and a remote location. The antenna 716 can be attached to the housing 708 and electrically coupled to the transceiver 714. In some implementations, the wireless device 700 can also include multiple transmitters, multiple receivers, multiple transceivers, and/or multiple antennas (not illustrated).

The signal detector 718 can be used to detect and quantify the level of signals received by the transceiver 714. The signal detector 718 can detect such signals as total energy, energy per subcarrier per symbol, and/or power spectral density and in other ways.

The digital signal processor (DSP) 720 can be used to process signals. The DSP 220 can be configured to generate a packet for transmission. In some aspects, the packet can include a physical layer data unit (PPDU).

The user interface 722 can include, for example, a keypad, a microphone, a speaker, and/or a display. The user interface 722 can include any element or component that conveys information to a user of the wireless device 700 and/or receives input from a user.

The various components of the wireless device 700 can be coupled together by a bus system 724. The bus system 724 can include a data bus, and can also include a power bus, a control signal bus, and/or a status signal bus in addition to the data bus.

The wireless device 700 can also include other components or elements not illustrated in FIG. 7. One or more of the components of the wireless device 700 can be in communication with another one or more components of the wireless device 700 by means of another communication channel (not illustrated) to provide, for example, an input signal to the other component.

Although a number of separate components are illustrated in FIG. 7, one or more of the components can be combined or commonly implemented. For example, the processor 704 and the memory 706 can be embodied on a single chip. The processor 704 can additionally, or in the alternative, contain memory, such as processor registers. Similarly, one or more of the functional blocks or portions of the functionality of various blocks can be embodied on a single chip. Alternatively, the functionality of a particular block can be implemented on two or more chips. For example, the processor 704 can be used to implement not only the functionality described above with respect to the processor 704, but also to implement the functionality described above with respect to the signal detector 718 and/or the DSP 720.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for detecting playback buffer underrun at a sink device, comprising:
establishing a connection with the sink device according to a short-range wireless communication protocol;
streaming multimedia data to the sink device over the established connection, wherein the sink device stores the streamed multimedia data in a playback buffer and renders the streamed multimedia data from the playback buffer; and
increasing local resources allocated to streaming the multimedia data to the sink device in response to a signal received from the sink device indicating that the multimedia data stored in the playback buffer at the sink device has fallen below a threshold.

2. The method recited in claim 1, further comprising:
increasing the local resources allocated to streaming the multimedia data to the sink device in response to detecting packet loss due to radio frequency (RF) interference.

3. The method recited in claim 1, further comprising:
transmitting the multimedia data to the sink device at an increased frequency in response to the signal received from the sink device indicating that the multimedia data stored in the playback buffer at the sink device has fallen below the threshold.

4. The method recited in claim 1, further comprising:
decreasing the local resources allocated to streaming the multimedia data to the sink device in response to the sink device indicating that the multimedia data stored in the playback buffer has increased above the threshold.

5. The method recited in claim 1, wherein the connection comprises an Asynchronous Connection-Less (ACL) session and the increased local resources comprise local buffer resources that a Host Controller Interface (HCI) has allocated to another ACL session.

6. The method recited in claim 1, wherein the streamed multimedia data comprises audio content streamed to the sink device according to an Advanced Audio Distribution Profile (A2DP).

7. The method recited in claim 1, wherein the streamed multimedia data comprises video content streamed to the sink device according to a Video Distribution Profile (VDP).

8. The method recited in claim 7, wherein the streamed multimedia data further comprises audio content streamed to the sink device according to an Advanced Audio Distribution Profile (A2DP) to accompany the video content streamed to the sink device.

9. A media source device, comprising:
means for establishing a connection with a media sink device according to a short-range wireless communication protocol;
means for streaming multimedia data to the media sink device over the established connection, wherein the media sink device stores the streamed multimedia data in a playback buffer and renders the streamed multimedia data from the playback buffer; and
means for increasing local resources allocated to streaming the multimedia data to the media sink device in response to a signal received from the media sink device indicating that the multimedia data stored in the playback buffer at the media sink device has fallen below a threshold.

10. The media source device recited in claim 9, further comprising:
means for increasing the local resources allocated to streaming the multimedia data to the media sink device in response to detecting packet loss due to radio frequency (RF) interference.

11. The media source device recited in claim 9, further comprising:
means for transmitting the multimedia data to the media sink device at an increased frequency in response to the signal received from the media sink device indicating that the multimedia data stored in the playback buffer at the media sink device has fallen below the threshold.

12. The media source device recited in claim 9, further comprising:
means for decreasing the local resources allocated to streaming the multimedia data to the media sink device in response to the media sink device indicating that the multimedia data stored in the playback buffer has increased above the threshold.

13. The media source device recited in claim 9, wherein the connection comprises an Asynchronous Connection-Less (ACL) session and the increased local resources comprise local buffer resources that a Host Controller Interface (HCI) has allocated to another ACL session.

14. The media source device recited in claim 9, wherein the streamed multimedia data comprises audio content streamed to the media sink device according to an Advanced Audio Distribution Profile (A2DP).

15. The media source device recited in claim 9, wherein the streamed multimedia data comprises video content streamed to the media sink device according to a Video Distribution Profile (VDP).

16. The media source device recited in claim 15, wherein the streamed multimedia data further comprises audio content streamed to the media sink device according to an Advanced Audio Distribution Profile (A2DP) to accompany the video content streamed to the media sink device.

17. A computer-readable storage medium having computer-executable instructions recorded thereon, wherein executing the computer-executable instructions on a wireless device causes the wireless device to:
establish a connection with a media sink device according to a short-range wireless communication protocol;
stream multimedia data to the media sink device over the established connection, wherein the media sink device stores the streamed multimedia data in a playback buffer and renders the streamed multimedia data from the playback buffer; and
increase local resources allocated to streaming the multimedia data to the media sink device in response to a signal received from the media sink device indicating that the multimedia data stored in the playback buffer at the media sink device has fallen below a threshold.

18. The computer-readable storage medium recited in claim 17, wherein executing the computer-executable instructions on the wireless device further causes the wireless device to:
increase the local resources allocated to streaming the multimedia data to the media sink device in response to detecting packet loss due to radio frequency (RF) interference.

19. The computer-readable storage medium recited in claim 17, wherein executing the computer-executable instructions on the wireless device further causes the wireless device to:
transmit the multimedia data to the media sink device at an increased frequency in response to the signal received from the media sink device indicating that the multimedia data stored in the playback buffer at the media sink device has fallen below the threshold.

20. The computer-readable storage medium recited in claim 17, wherein executing the computer-executable instructions on the wireless device further causes the wireless device to:
decrease the local resources allocated to streaming the multimedia data to the media sink device in response to the media sink device indicating that the multimedia data stored in the playback buffer has increased above the threshold.

21. The computer-readable storage medium recited in claim 17, wherein the connection comprises an Asynchronous Connection-Less (ACL) session, the increased local resources comprise local buffer resources that a Host Controller Interface (HCI) has allocated to another ACL session, and the streamed multimedia data comprises audio content streamed to the media sink device according to an Advanced Audio Distribution Profile (A2DP).

22. The computer-readable storage medium recited in claim 17, wherein the streamed multimedia data comprises video content streamed to the media sink device according to a Video Distribution Profile (VDP) and audio content streamed to the media sink device according to an Advanced Audio Distribution Profile (A2DP) to accompany the video content streamed to the media sink device according to the VDP.

23. An apparatus, comprising:
a transmitter configured to stream multimedia data to a sink device over a short-range wireless connection, wherein the sink device is configured to store the streamed multimedia data in a playback buffer and render the streamed multimedia data from the playback buffer;
a receiver configured to receive a signal from the sink device indicating that the streamed multimedia data stored in the playback buffer has fallen below a threshold; and
one or more processors configured to increase local resources allocated to the short-range wireless connection used to stream the multimedia data to the sink device in response to the received signal from the sink device.

24. The apparatus recited in claim 23, further comprising:
a signal detector configured to detect packet loss due to radio frequency (RF) interference on the short-range wireless connection, wherein the one or more processors are further configured to increase the local resources allocated to the short-range wireless connection used to stream the multimedia data to the sink device in response to the detected packet loss.

25. The apparatus recited in claim 23, wherein the transmitter is further configured to transmit the streamed multimedia data to the sink device at an increased frequency in response to the signal received from the sink device.

26. The apparatus recited in claim 23, wherein:
the one or more processors are further configured to decrease the local resources allocated to the short-range wireless connection used to stream the multimedia data to the sink device in response to the sink device indicating that the streamed multimedia data stored in the playback buffer has increased above the threshold.

27. The apparatus recited in claim 23, wherein the short-range wireless connection comprises an Asynchronous Connection-Less (ACL) session and the local resources comprise local buffer resources that a Host Controller Interface (HCI) has allocated to another ACL session.

28. The apparatus recited in claim 23, wherein the streamed multimedia data comprises audio content streamed to the sink device according to an Advanced Audio Distribution Profile (A2DP).

29. The apparatus recited in claim 23, wherein the streamed multimedia data comprises video content streamed to the sink device according to a Video Distribution Profile (VDP).

30. The apparatus recited in claim 29, wherein the streamed multimedia data further comprises audio content streamed to the sink device according to an Advanced Audio Distribution Profile (A2DP) to accompany the video content streamed to the sink device.
